(19) United States
(12) Patent Application Publication
(10) Pub. No.: US 2014/0354662 A1
(43) Pub. Date: Dec. 4, 2014

(54) DISPLAY DEVICE

(71) Applicant: Tomoaki Saito, Tokyo (JP)

(72) Inventor: Tomoaki Saito, Tokyo (JP)

(73) Assignee: Mitsubishi Electric Corporation, Tokyo (JP)

(21) Appl. No.: 14/370,352

(22) PCT Filed: Feb. 2, 2012
(86) PCT No.: PCT/JP12/00713

§ 371 Date: Jul. 2, 2014

(51) Int. Cl. G06T 1/20

(52) U.S. Cl. CPC G06T 1/20
USPC 345/522

(57) ABSTRACT

A CPU transmits to a graphics accelerator 4 an ID data arrangement command for setting in an ID table display list IDs contained in ID data corresponding to target images drawn in display order, and a drawing execution command for designating the display list IDs contained in the ID data set in the ID table in accordance with the ID data arrangement command. The graphics accelerator sets in the ID table the display list IDs contained in the ID data designated by the ID data arrangement command from the CPU among the ID data of the ID data group, and executes drawing processing of images using the display lists read from a display list group by the display list IDs designated by the drawing execution command from the CPU among the display list IDs in the ID table.

### TECHNICAL FIELD

The present invention relates to a display device with a graphics accelerator that executes drawing processing using display lists.

### BACKGROUND ART

Among conventional display devices, to speed up the drawing processing, there are some devices that cause the CPU of a host computer to record display lists which provide display modes of the individual elements constituting a drawing target image in a memory of a graphics accelerator in advance.

In such a display device, the graphics accelerator creates identification information that designates a display list stored in the memory and transfers it to the CPU of the host computer. When executing the drawing processing, the CPU of the host computer transfers a drawing execution command in which the identification information is set to the graphics accelerator.

The graphics accelerator executes the drawing processing using the display list corresponding to the identification information set in the drawing execution command, and writes the acquired image information in the frame buffer, thereby displaying a drawing target image on a display screen (see Patent Document 1, for example).

### PRIOR ART DOCUMENT

### Patent Document

Patent Document 1: Japanese Patent Laid-Open No. 2000-293151.

### DISCLOSURE OF THE INVENTION

To execute the drawing processing of a plurality of images using a plurality of display lists, the conventional display device does not employ hierarchical relationships as to the display order of the individual elements constituting the drawing target images and the display order of the individual drawing target images, but has to collectively designate the identification information about all the display lists corresponding to the plurality of drawing target images. Thus, it must prepare in advance the identification information for uniquely identifying the display lists by the number of the display lists corresponding to the plurality of drawing target images.

Here, since hardware such as a graphics accelerator that executes the drawing processing has the upper limit as to the number of unique IDs it can set, there is a possibility that a large number of display lists are created during development of an application or the like, and the IDs cannot be assigned without overlapping when drawing a plurality of images. For example, as for hardware that executes arithmetic processing of 16-bit integer data, although it can set IDs from 0 to 65535 (=2¹⁶−1), it cannot set IDs exceeding the upper limit value 65535.

The present invention is implemented to solve the foregoing problem. Therefore it is an object of the present invention to provide a display device capable of preventing allocation shortage of IDs for identifying the display lists.

### Means for Solving the Problem

A display device in accordance with the present invention comprises: a CPU of a host computer; a graphics accelerator that has a memory which stores a display list group including a plurality of display lists which provide display modes of individual elements constituting a plurality of images, an ID data group including a plurality of ID data which gather display list IDs for uniquely identifying the display lists of individual images used for drawing, and an ID table in which the display list IDs contained in the ID data are set, the graphics accelerator executing drawing processing of the images using the display lists; and a display unit that displays the images drawn by the graphics accelerator, wherein the CPU transmits to the graphics accelerator an ID data arrangement command for setting in the ID table the display list IDs contained in the ID data corresponding to target images drawn in display order, and a drawing execution command for designating the display list IDs contained in the ID data set in the ID table in accordance with the ID data arrangement command; and the graphics accelerator sets in the ID table the display list IDs contained in the ID data designated by the ID data arrangement command from the CPU among the ID data of the ID data group, and executes drawing processing of the images using the display lists read out of the display list group according to the display list IDs designated by the drawing execution command from the CPU among the display list IDs in the ID table.

### Advantages of the Invention

According the present invention, it offers an advantage of being able to prevent the allocation shortage of the IDs for identifying the display lists.

### BRIEF DESCRIPTION OF THE DRAWINGS

FIG. 1 is a block diagram showing a configuration of a display device of an embodiment 1 in accordance with the present invention;

FIG. 2 is a diagram showing an outline of a dynamic allocation operation of ID data by the display device of the embodiment 1;

FIG. 3 is a diagram showing relationships between display contents of menu images and the arrangement of ID data in an ID table; and

FIG. 4 is a diagram showing an outline of ID data creation in accordance with a hierarchical structure about a menu drawing of a display list group.

### BEST MODE FOR CARRYING OUT THE INVENTION

The best mode for carrying out the invention will now be described with reference to the accompanying drawings to explain the present invention in more detail.

### Embodiment 1

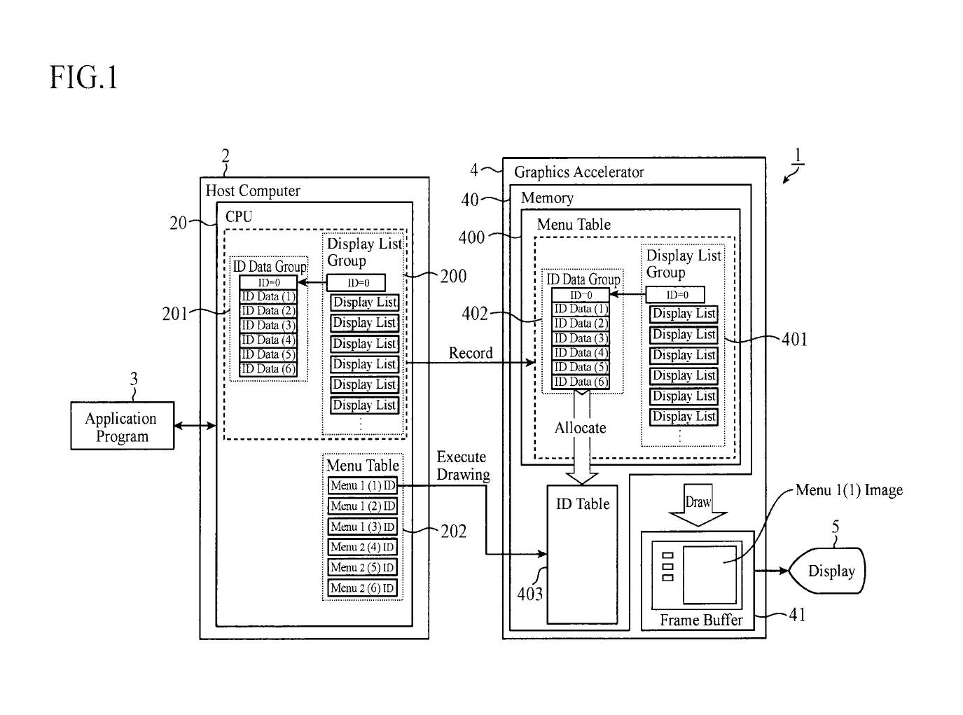

FIG. 1 is a block diagram showing a configuration of a display device of an embodiment 1 in accordance with the present invention. The display device 1 shown in FIG. 1 comprises a host computer 2, an application program 3, a graphics accelerator 4 and a display 5.

A CPU 20 of the host computer 2 executes an application program 3 developed on an internal memory (not shown in FIG. 1). In addition, when executing drawing processing by performing the application program 3, the CPU 20 transfers a drawing execution command to the graphics accelerator 4.

Incidentally, in the display device 1 of the embodiment 1, the CPU 20 stores contents of display list group 200 and ID data group 201 about menu images, which are to be drawn by executing the application program 3, in a memory 40 of the graphics accelerator 4 before the drawing processing.

The display list group 200 consists of a plurality of display lists about a plurality of menu images, and the plurality of display lists provide hierarchical relationships about display order of the individual menu images and display order of the individual elements constituting the menu images.

For example, when a menu 1 image is displayed as the hierarchical relationships about the display order of the individual elements constituting the menu image such as a menu 1(1) image, a menu 1(2) image and menu 1(3) image in a superposed manner in this order, the information that provides the display mode of the menu 1(1) image is placed at a high level, and then the information about the menu 1(2) and the information about the menu 1(3) are placed at a lower level in this order.

The ID data group 201 consists of a plurality of ID data corresponding to the display lists of the display list group 200. The ID data is data that gathers the display list IDs of the display lists necessary for drawing the menu images. In addition, the display list ID, which is an ID that uniquely identifies a display list, is an ID on an ID table 403 that will be described later. In other words, the display list ID becomes an ID number assigned in the ID table 403.

The example shown in FIG. 1 uses for drawing the menu 1 image the ID data (1) that gathers the display list IDs of the display lists necessary for drawing the menu 1(1) image, the ID data (2) that gathers the display list IDs of the display lists necessary for drawing the menu 1(2) image, and the ID data (3) that gathers the display list IDs of the display lists necessary for drawing the menu 1(3) image.

In addition, it uses for drawing the menu 2 image the ID data (4) that gathers the display list IDs of the display lists necessary for drawing the menu 2(4) image, the ID data (5) that gathers the display list IDs of the display lists necessary for drawing the menu 2(5) image, and the ID data (6) that gathers the display list IDs of the display lists necessary for drawing the menu 2(6) image.

A menu table 202 is table data that records the menu IDs of the menu images. Here, a menu ID is an ID that designates a menu image that starts drawing (begins drawing), and is related to the ID data used for drawing the menu image. When drawing a menu image by executing the application program 3, the CPU 20 specifies the ID data used for drawing the menu image from the menu IDs stored in the menu table 202, specifies the display list IDs of the display lists necessary for drawing the menu image contained in the ID data, and transmits to the graphics accelerator 4 an ID data arrangement command that sets into the ID table 403 the display list IDs contained in the ID data specified and a drawing execution command that designates the display list IDs specified as an argument.

In FIG. 1, the menu 1(1) ID is a drawing start ID that instructs to draw the menu 1(1) image, the menu 1(2) ID is a drawing start ID that instructs to draw the menu 1(2) image, and the menu 1(3) ID is a drawing start ID that instructs to draw the menu 1(3) image. In addition, the menu 2(4) ID is a drawing start ID that instructs to draw the menu 2(4) image, the menu 2(5) ID is a drawing start ID that instructs to draw the menu 2(5) image, and the menu 2(6) ID is a drawing start ID that instructs to draw the menu 2(6) image.

In the following, a description will be made of an example which stores the display lists and ID data necessary for drawing a menu image (menu 1) consisting of the three elements (menu 1(1), menu 1(2), and menu 1(3)), and a menu image (menu 2) consisting of the three elements (menu 2(4), menu 2(5), and menu 2(6)) in the memory 40 of the graphics accelerator 4.

Incidentally, in real application development, information about all the menus (display lists and ID data) acquired by executing the application program 3 is stored in the graphics accelerator 4.

The graphics accelerator 4 is graphics hardware that displays arithmetic resulting image data received from the host computer 2 on the display 5, and comprises the memory 40 and a frame buffer 41.

The memory 40 is a storage unit that stores a menu table 400 comprising a display list group 401 and an ID data group 402, and the ID table 403. In the display list group 401, the CPU 20 records the contents of the display list group 200. Likewise, in the ID data group 402, the CPU 20 records the contents of the ID data group 201.

The ID table 403 is table data in which the ID data used in the drawing processing of the graphics accelerator 4 is disposed. The ID data stores the display list IDs of various types of display lists.

Here, as the types of the display lists, there are a container that stores any number of the display lists designated by the display list IDs, text information used by text drawing, font information designating a font, vector graphics drawing data used for vector graphics drawing, bitmap information used for image drawing, and animation information used for animation drawing.

Incidentally, the container can store another container and can provide a hierarchical structure.

Thus, the display lists can provide the hierarchical structure by forming data by storing a container or other types of display lists designated by the display list IDs in a container.

The frame buffer 41 is a frame buffer in which information (bitmap data) of an image to be displayed on the display 5 is written. The graphics accelerator 4 executes the drawing processing using the information of the display lists designated by the ID data, thereby writing the information about the acquired menu image in the frame buffer 41. The display 5 is a display unit that reads out the image information written in the frame buffer 41 and displays the image.

Next the operation will be described.

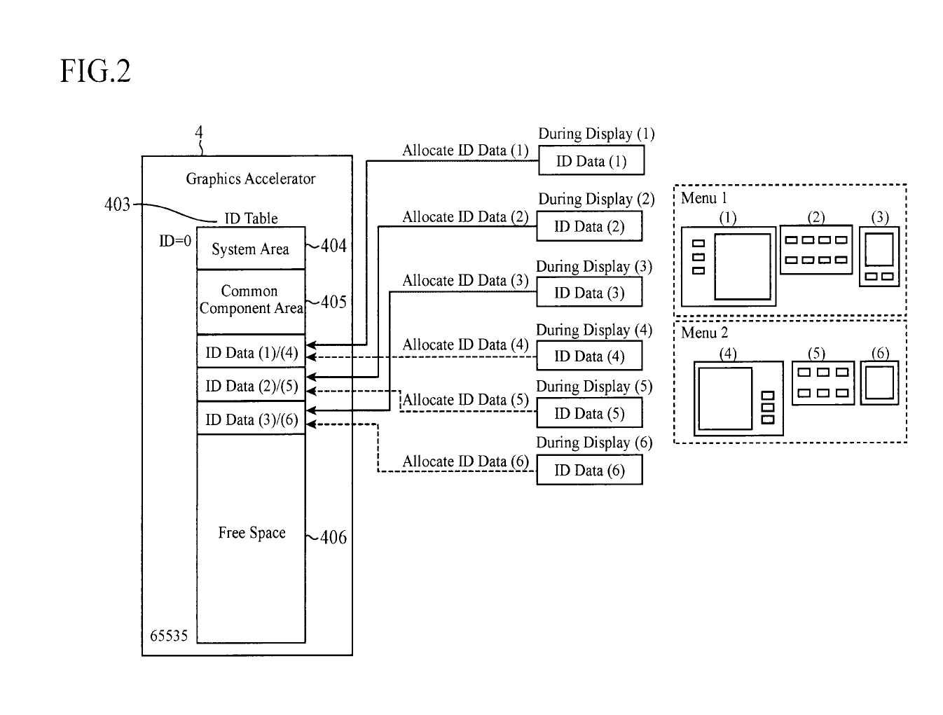

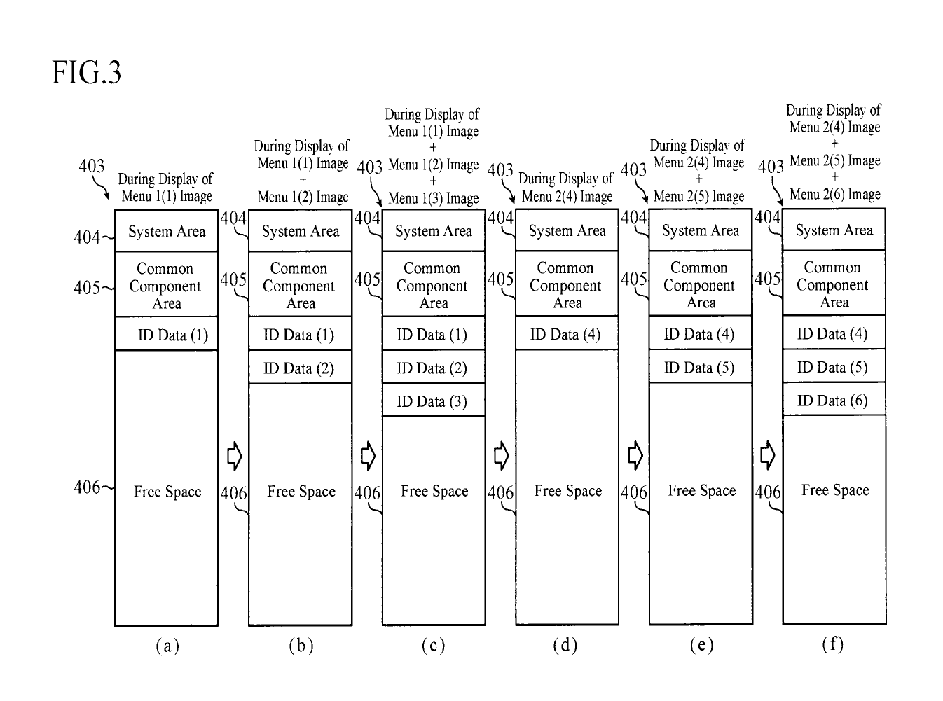

FIG. 2 is a diagram showing an outline of the dynamic allocation operation of the ID data by the display device of the embodiment 1. In addition, FIG. 3 is a diagram showing relationships between the menu image display contents and the ID data arrangement states in the ID table. The ID table 403 shown in FIG. 2, which can enable 0-65535 to be set as the display list IDs, provides a system area 404 from ID=0 to a prescribed address, followed by providing a common component area 405, and an ID area after the common component area 405 forms a free space 406.

Here, the system area 404 sets the display list IDs used by the drawing processing the graphics accelerator 4 is executing now, a font ID used by the whole system comprising the host computer 2 and graphics accelerator 4, or the display list IDs of the display lists the system uses independently. The common component area 405 is an ID area to which the display list IDs that provide the display modes of display components commonly used by the drawing processing are assigned.

In addition, an assignable numerical values (0-65535) are put to the display list IDs collected in the ID data in the ID table 403.

Incidentally, “to allocate the ID data in the ID table 403” mentioned in the present invention corresponds to the processing of determining the numerical values to which the display list IDs contained in the ID data are set in the ID table 403.

FIG. 2 and FIG. 3 show an example that draws the menu 1 image composed of the individual elements of the menu 1(1), menu 1(2), and menu 1(3), and the menu 2 image composed of the individual elements of the menu 2(4), menu 2(5), and menu 2(6). Incidentally, it is assumed from the hierarchical relationships of the display order that the images of the menu 1 and the images of the menu 2 are not displayed simultaneously on the display 5.

The processing of dynamically disposing the ID data in the ID table 403 and of drawing the menu 1 image and menu 2 image will be described below with reference to FIG. 1, FIG. 2 and FIG. 3.

### (A) Drawing Processing According to Dynamic Arrangement of ID Data in ID Table.

First, the CPU 20 records in the menu table 400 of the graphics accelerator 4 the display lists used for drawing the menu 1 image prepared in advance, the display lists used for drawing the menu 2 image, and the ID data that gathers the individual display list IDs of the display lists about the menu 1 and menu 2.

The menu 1(1) image is drawn first according to the hierarchical relationships of the display order provided by the display lists. First, as shown in FIG. 1, the CPU 20 reads out the menu 1(1) ID from the menu table 202, specifies the ID data (1) used for drawing the menu 1(1) image from the menu 1(1) ID, and transmits to the graphics accelerator 4 the ID data arrangement command for placing the ID data (1) in the ID table 403.

Receiving the ID data arrangement command from the CPU 20, the graphics accelerator 4 dynamically places in the ID table 403, as shown in FIG. 2, the ID data (1) designated by the ID data arrangement command among the ID data recorded in the ID data group 402.

More specifically, when drawing the menu 1(1) image, the display list IDs contained in the ID data (1) are set at numerical values possible in the free space 406 of the ID table 403. The contents of the ID table 403 at this time are as shown at display (a) of the menu 1(1) image in FIG. 3.

When the graphics accelerator 4 places the ID data (1) in the ID table 403 in accordance with the ID data arrangement command, the CPU 20 transmits to the graphics accelerator 4 a drawing command with an argument consisting of the display list IDs of the display lists necessary for drawing the menu 1(1) image contained in the ID data (1).

The graphics accelerator 4 executes the drawing processing of the menu 1(1) image using the display lists uniquely identified by the display list IDs designated by the drawing execution command from the CPU 20 from among the display list IDs of the ID data (1) placed in the ID table 403, and writes the acquired menu 1(1) image information in the frame buffer 41. This will cause the display 5 to read out the image information written in the frame buffer 41 and to display the menu 1(1) image.

Next, the menu 1(2) image is drawn according to the hierarchical relationships of the display order provided by the display lists. In this case, the CPU 20 reads out the menu 1(2) ID from the menu table 202, specifies the ID data (2) used for drawing the menu 1(2) image from the menu 1(2) ID, and transmits to the graphics accelerator 4 the ID data arrangement command for placing the ID data (2) in the ID table 403.

Receiving the ID data arrangement command from the CPU 20, the graphics accelerator 4 dynamically places in the ID table 403, as shown in FIG. 2, the ID data (2) designated by the ID data arrangement command among the ID data recorded in the ID data group 402. More specifically, when drawing the menu 1(2) image, the display list IDs contained in the ID data (2) are set at numerical values possible in the free space 406 of the ID table 403. The contents of the ID table 403 at this time are as shown at display (b) of the menu 1(1) image+menu 1(2) image in FIG. 3.

When the graphics accelerator 4 places the ID data (2) in the ID table 403 in accordance with the ID data arrangement command, the CPU 20 specifies the display list IDs of the display lists necessary for drawing the menu 1(2) image from the ID data (2), and transmits to the graphics accelerator 4 a drawing execution command with an argument consisting of the display list IDs specified.

The graphics accelerator 4 executes the drawing processing of the menu 1(2) image using the display lists uniquely identified by the display list IDs designated by the drawing execution command from the CPU 20 from among the display list IDs of the ID data (2) placed in the ID table 403, and overwrites the acquired menu 1(2) image information in the frame buffer 41 in which the menu 1(1) image information has been written. This will cause the display 5 to read out the image information written in the frame buffer 41 and to display the menu 1(2) image in a manner superposed on the menu 1(1) image.

Next, the menu 1(3) image is drawn according to the hierarchical relationships of the display order provided by the display lists. In this case, the CPU 20 reads out the menu 1(3) ID from the menu table 202, specifies the ID data (3) used for drawing the menu 1(3) image from the menu 1(3) ID, and transmits to the graphics accelerator 4 the ID data arrangement command for placing the ID data (3) in the ID table 403.

Receiving the ID data arrangement command from the CPU 20, the graphics accelerator 4 dynamically places in the ID table 403, as shown in FIG. 2, the ID data (3) designated by the ID data arrangement command among the ID data recorded in the ID data group 402. More specifically, when drawing the menu 1(3) image, the display list IDs contained in the ID data (3) are set at numerical values possible in the free space 406 of the ID table 403. The contents of the ID table 403 at this time are as shown at display (c) of the menu 1(1) image+menu 1(2) image+menu 1(3) image in FIG. 3.

When the graphics accelerator 4 places the ID data (3) in the ID table 403 in accordance with the ID data arrangement command, the CPU 20 specifies the display list IDs of the display lists necessary for drawing the menu 1(3) image from the ID data (3), and transmits to the graphics accelerator 4 a drawing execution command with an argument consisting of the display list IDs specified.

The graphics accelerator 4 executes the drawing processing of the menu 1(3) image using the display lists uniquely identified by the display list IDs designated by the drawing execution command from the CPU 20 from among the display list IDs of the ID data (3) placed in the ID table 403, and overwrites the acquired menu 1(3) image information in the frame buffer 41 in which the menu 1(1) image information and the menu 1(2) image information have been written. This will cause the display 5 to read out the image information written in the frame buffer 41 and to display the menu 1(3) image in a manner further superposed on the menu 1(2) image which is superposed on the menu 1(1) image.

Since the menu 1 image and menu 2 image are not displayed simultaneously on the display 5 according to the hierarchical relationships of the display order provided by the display lists, the menu 2(4) image is drawn next. In this case, the CPU 20 reads out the menu 2(4) ID from the menu table 202, specifies the ID data (4) used for drawing the menu 2(4) image from the menu 2(4) ID, and transmits to the graphics accelerator 4 the ID data arrangement command for placing the ID data (4) in the ID table 403.

Receiving the ID data arrangement command from the CPU 20, the graphics accelerator 4 dynamically places in the ID table 403, as shown in FIG. 2, the ID data (4) designated by the ID data arrangement command among the ID data recorded in the ID data group 402.

Here, since the menu 1 image and menu 2 image are not displayed simultaneously on the display 5, the arrangement of the ID data (1), ID data (2), and ID data (3) about the menu 1 image is relinquished, and the ID area is used again for the arrangement of the ID data about the menu 2 image.

More specifically, as for the display list IDs of the ID data about the menu images which are displayed more or less at the same time but not simultaneously on the display 5, they can be assigned to the same numerical values possible in the free space 406 of the ID table 403.

This enables, when drawing the menu 2(4) image, the display list IDs of the ID data (4) to be set at the numerical values possible in the free space 406 of the ID table 403 (the numerical values once assigned to the display list IDs about the menu 1). The contents of the ID table 403 at this time are at display (d) of the menu 2(4) image in FIG. 3.

When the graphics accelerator 4 places the ID data (4) in the ID table 403 in accordance with the ID data arrangement command, the CPU 20 specifies the display list IDs of the display lists necessary for drawing the menu 2(4) image from the ID data (4), and transmits to the graphics accelerator 4 a drawing execution command with an argument consisting of the display list IDs specified.

The graphics accelerator 4 executes the drawing processing of the menu 2(4) image using the display lists uniquely identified by the display list IDs designated by the drawing execution command from the CPU 20 from among the display list IDs of the ID data (4) placed in the ID table 403. Incidentally, since the menu 1 image and the menu 2 image are not displayed simultaneously on the display 5, the menu 1 image information in the frame buffer 41 has been deleted. The graphics accelerator 4 writes the acquired menu 2(4) image information in the frame buffer 41 by the drawing processing. This causes the display 5 to read out the image information written in the frame buffer 41 and to display the menu 2(4) image.

Next, the menu 2(5) image is drawn according to the hierarchical relationships of the display order provided by the display lists. In this case, the CPU 20 reads out the menu 2(5) ID from the menu table 202, specifies the ID data (5) used for drawing the menu 2(5) image from the menu 2(5) ID, and transmits to the graphics accelerator 4 the ID data arrangement command for placing the ID data (5) in the ID table 403.

Receiving the ID data arrangement command from the CPU 20, the graphics accelerator 4 dynamically places in the ID table 403, as shown in FIG. 2, the ID data (5) designated by the ID data arrangement command among the ID data recorded in the ID data group 402. More specifically, when drawing the menu 2(5) image, the display list IDs of the ID data (5) are set at numerical values possible in the free space 406 of the ID table 403. The contents of the ID table 403 at this time are as shown at display (e) of the menu 2(4) image+menu 2(5) image in FIG. 3.

When the graphics accelerator 4 places the ID data (5) in the ID table 403 in accordance with the ID data arrangement command, the CPU 20 specifies the display list IDs of the display lists necessary for drawing the menu 2(5) image from the ID data (5), and transmits to the graphics accelerator 4 a drawing execution command with an argument consisting of the display list IDs specified.

The graphics accelerator 4 executes the drawing processing of the menu 2(5) image using the display lists uniquely identified by the display list IDs designated by the drawing execution command from the CPU 20 from among the display list IDs of the ID data (5) placed in the ID table 403, and overwrites the acquired menu 2(5) image information in the frame buffer 41 in which the menu 2(4) image information has been written. This will cause the display 5 to read out the image information written in the frame buffer 41 and to display the menu 2(5) image an a manner superposed on the menu 2(4) image.

Next, the menu 2(6) image is drawn according to the hierarchical relationships of the display order provided by the display lists. In this case, the CPU 20 reads out the menu 2(6) ID from the menu table 202, specifies the ID data (6) used for drawing the menu 2(6) image from the menu 2(6) ID, and transmits to the graphics accelerator 4 the ID data arrangement command for placing the ID data (6) in the ID table 403.

Receiving the ID data arrangement command from the CPU 20, the graphics accelerator 4 dynamically places in the ID table 403, as shown in FIG. 2, the ID data (6) designated by the ID data arrangement command among the ID data recorded in the ID data group 402. More specifically, when drawing the menu 2(6) image, the display list IDs of the ID data (6) are set at numerical values possible in the free space 406 of the ID table 403. The contents of the ID table 403 at this time are as shown at display (f) of the menu 2(4) image+menu 2(5) image+menu 2(6) image in FIG. 3.

When the graphics accelerator 4 places the ID data (6) in the ID table 403 in accordance with the ID data arrangement command, the CPU 20 specifies the display list IDs of the display lists necessary for drawing the menu 2(6) image from the ID data (6), and transmits to the graphics accelerator 4 a drawing execution command with an argument consisting of the display list IDs specified.

The graphics accelerator 4 executes the drawing processing of the menu 2(6) image using the display lists uniquely identified by the display list IDs designated by the drawing execution command from the CPU 20 from among the display list IDs of the ID data (6) placed in the ID table 403, and overwrites the acquired menu 2(6) image information in the frame buffer 41 in which the menu 2(4) image information and the menu 2(5) image information have been written. This will cause the display 5 to read out the image information written in the frame buffer 41 and to display the menu 2(6) image in a manner further superposed on the menu 2(5) image which is superposed on the menu 2(4) image.

The conventional display device, when executing the drawing processing using the plurality of display lists as described before, carries out the drawing execution command that gathers all the ID data corresponding to the plurality of display lists, and places all the ID data in the free space of the ID table 403 (static arrangement). For example, at the drawing processing when displaying the menu 1 image and the menu 2 image, the display list IDs from the ID data (1) to the ID data (6) are set in the free space of the ID table 403 all at once. Accordingly, when there are a lot of drawing target menu images, there is a possibility that the display list IDs cannot be assigned.

In contrast with this, according to the present invention, even if the number of the drawing target menu images is great, it sets only the display list IDs of the ID data used for the drawing processing in the free space of the ID table 403 when executing the drawing of the individual menu images according to the hierarchical relationships of the display list. This enables preventing the display list IDs from becoming unassignable.

Incidentally, as for the placement of the ID data in the ID table 403, the BitBlt function can be used which the graphics accelerator 4 has in general.

More specifically, the graphics accelerator 4 sets the display list IDs of the ID data in the ID table 403 using the BitBlt transfer in accordance with the ID data arrangement command issued by the CPU 20. This will enable faster ID data arrangement.

### (B) ID Data Creation According to Hierarchical Structure of Display List Group.

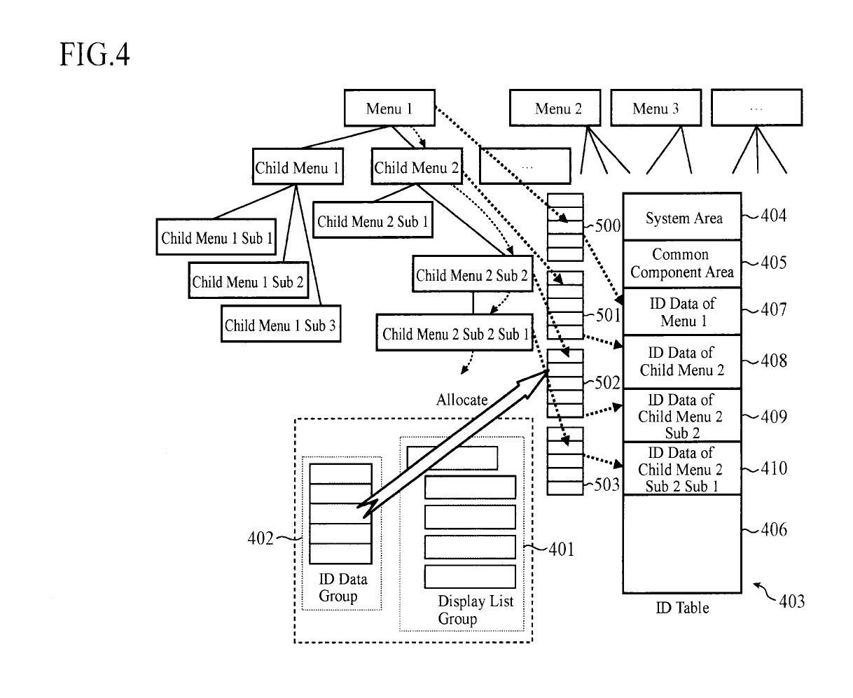

FIG. 4 is a diagram showing an outline of ID data creation according to a hierarchical structure as to the menu drawing of a display list group. In FIG. 4, menu 1, menu 2, menu 3, . . . , denote display list groups having the hierarchical relationships of the display order used for drawing the menu images.

The images of the menu 1, menu 2, menu 3, . . . are menu images displayed by executing the application program 3. Incidentally, the images in the high-level menu 1, menu 2, menu 3, . . . are not displayed simultaneously on the display 5.

In addition, next to the menu 1 image, one of the child menu 1 image and child menu 2 image is displayed. When the child menu 1 image is displayed next, one of the child menu 1 sub 1 image, child menu 1 sub 2 image, and child menu 1 sub 3 image is displayed next.

When the child menu 2 image is displayed next, one of the child menu 2 sub 1 image and child menu 2 sub 2 image is displayed next, and when the child menu 2 sub 2 image is displayed, the child menu 2 sub 2 sub 1 image is displayed next.

The hierarchical relationships of the display order are provided in the display lists used for the drawing processing of the individual menu images. In the following, the ID data creation operation will be described for displaying the menu 1 image, child menu 2 image, child menu 2 sub 2 image, and child menu 2 sub 2 sub 1 image in this order. Incidentally, the foregoing display lists and ID data are created during the development of the application program 3, and are stored in the memory 40 of the graphics accelerator 4 by the CPU 20 at the start of the display device 1 in accordance with the present invention.

At the creation of ID data 500 used for drawing the menu 1 image, the numerical value following the end of the common component area 405 of the ID table 403 is determined as an offset 1, and the display list IDs of the ID data 500 are assigned to an ID area 407 beginning from the offset 1. At this time, the ID area 407 is specified by adding to the offset 1 the number of IDs necessary for the ID data 500, that is, the number of the display lists used for drawing the menu 1 image, and the display list IDE used for drawing the menu 1 image are assigned from the beginning (offset 1) of the ID area 407.

At the creation of the ID data 501 used for drawing the child menu 2 image, the numerical value following the end of the ID area 407 is determined as an offset 2, and the display list IDs of the ID data 501 are assigned to an ID area 408 beginning from the offset 2. At this time, the ID area 408 is specified by adding to the offset 2 the number of IDs necessary for the ID data 501, that is, the number of the display lists used for drawing the child menu 2 image, and the display list IDs used for drawing the child menu 2 image are assigned from the beginning of the ID area 408.

At the creation of the ID data 502 used for drawing the child menu 2 sub 2 image, the numerical value following the end of the ID area 408 is determined as an offset 3, and the display list IDs of the ID data 502 are assigned to an ID area 409 beginning from the offset 3. At this time, the ID area 409 is specified by adding to the offset 3 the number of IDs necessary for the ID data 502, that is, the number of the display lists used for drawing the child menu 2 sub 2 image, and the display list IDs used for drawing the child menu 2 sub 2 image are assigned from the beginning of the ID area 409.

At the creation of the ID data 503 used for drawing the child menu 2 sub 2 sub 1 image, the numerical value following the end of the ID area 409 is determined as an offset 4, and the display list IDs of the ID data 503 are assigned to an ID area 410 beginning from the offset 4. At this time, the ID area 410 is specified by adding to the offset 4 the number of IDs necessary for the ID data 503, that is, the number of the display lists used for drawing the child menu 2 sub 2 sub 1 image, and the display list IDs used for drawing the child menu 2 sub 2 sub 1 image are assigned from the beginning of the ID area 410.

After that, as for the ID data about the menu image displayed next to the child menu 2 sub 2 sub 1 image, the display list IDs are assigned to the ID area beginning from an offset 5 which is the numerical value following the end of the ID area 410.

Iterating the procedure in the hierarchy concerning the display order of all the menu images to create the ID data about the individual menu images enables creating the ID data that do not overlap as to the target menu images drawn simultaneously.

As described above, as for the images displayed on the display 5 simultaneously, the display list IDs of the ID data are assigned without overlapping in accordance with the hierarchical relationships of the display lists, and as for the images that are not displayed simultaneously on the display 5, the display list IDs of the ID data are assigned with overlapping being allowed. This enables dynamically placing the ID data for all the menus in the ID table 403 at the drawing, and enables reusing the same ID areas on the ID table 403 for the menu images that are not displayed simultaneously, thereby being able to prevent the allocation shortage of the display list IDs.

In addition, creating the ID data in accordance with the hierarchical relationships as described above offers the following advantage. For example, in the drawing processing described in the foregoing (A), to return to a previous menu such as displaying the menu 1 image and child menu 2 image in order, and then displaying the child menu 1 image instead of the child menu 2 image, it is possible to relinquish the ID area 501 of the ID table 403 in which the ID data 501 corresponding to the child menu 2 image is set, and to set the ID data corresponding to the child menu 1 image. This enables efficient use of the ID table 403 by the ID data.

As described above, according to the embodiment 1, it comprises the CPU 20 of the host computer 2; the graphics accelerator 4 with the memory 40 that stores the display list group 401 including a plurality of display lists which provide display modes of individual elements constituting a plurality of images, the ID data group 402 including a plurality of ID data which gathers the display list IDs which uniquely identify display lists of individual images used for drawing, and the ID table 403 in which the display list IDs contained in the ID data are set, and that executes drawing processing of the images using the display lists; and the display 5 that displays the images drawn by the graphics accelerator 4, wherein the CPU 20 transmits to the graphics accelerator 4 the ID data arrangement command for setting in the ID table 403 the display list IDs contained in the ID data corresponding to the target images drawn in the display order and the drawing execution command for designating the display list IDs contained in the ID data set in the ID table 403 in accordance with the ID data arrangement command; and the graphics accelerator 4 sets in the ID table 403 the display list IDs contained in the ID data designated by the ID data arrangement command from the CPU 20 among the ID data of the ID data group 402, and executes drawing processing of the images using the display lists read out of the display list group 401 according to the display list IDs designated by the drawing execution command from the CPU 20 among the display list IDs in the ID table. By thus doing, it becomes possible to execute high-speed drawing processing by efficiently using the ID data assigned to the display lists.

In addition, according to the present embodiment 1, the graphics accelerator 4 sets the display list IDs contained in the ID data designated by the ID data arrangement command from the CPU 20 into the ID table 403 by the BitBlt transfer. By thus doing, it becomes possible to set the ID data quickly.

Furthermore, according to the present embodiment 1, as for the images displayed on the display 5 simultaneously, the display list IDs are allocated without overlapping from the ID data group 402 in accordance with the hierarchical relationships of the display list group 402, and as for the imaged displayed not simultaneously on the display 5, the display list IDs are allocated with the overlapping being allowed.

By thus doing, it becomes possible to set the ID data dynamically in the ID table 403 at the drawing, and to reuse the same ID areas on the ID table 403 for the menu images not displayed simultaneously. Accordingly, the present embodiment can carry out high-speed drawing processing using the ID data assigned to the display lists, and can prevent the allocation shortage of the ID data.

Incidentally, it is to be understood that variations of any components of the embodiment or removal of any components of the embodiment is possible within the scope of the present invention.

### INDUSTRIAL APPLICABILITY

A display device in accordance with the present invention can prevent the allocation shortage of the IDs for identifying the display lists. Accordingly, it is suitably applied to a display device of an apparatus such as an onboard navigation system.

### DESCRIPTION OF REFERENCE SYMBOLS

1 display device; 2 host computer; 3 application program; 4 graphics accelerator; 5 display; 20 CPU; 40 memory; 41 frame buffer; 200, 401 display list group; 201, 402, 500-503 ID data; 202, 400 menu table; 403 ID table; 404 system area; 405 common component area; 406 free space; 407-410 ID area.

1. A display device comprising:
a CPU of a host computer;
a graphics accelerator that has a memory which stores a display list group including a plurality of display lists which provide display modes of individual elements constituting a plurality of images, an ID data group including a plurality of ID data which gather display list IDs for uniquely identifying the display lists of individual images used for drawing, and an ID table in which the display list IDs contained in the ID data are set, the graphics accelerator executing drawing processing of the images using the display lists; and
a display unit that displays the images drawn by the graphics accelerator, wherein
the CPU transmits to the graphics accelerator an ID data arrangement command for setting in the ID table the display list IDs contained in the ID data corresponding to target images drawn in display order, and a drawing execution command for designating the display list IDs contained in the ID data set in the ID table in accordance with the ID data arrangement command; and
the graphics accelerator sets in the ID table the display list IDs contained in the ID data designated by the ID data arrangement command from the CPU among the ID data of the ID data group, and executes drawing processing of the images using the display lists read out of the display list group according to the display list IDs designated by the drawing execution command from the CPU among the display list IDs in the ID table.

2-3. (canceled)

4. The display device according to claim 1, wherein
the ID data group is provided, as to images displayed on the display unit simultaneously, with allocation of the display list IDs without overlapping, and is provided, as to images not displayed simultaneously on the display unit, with allocation of the display list IDs with overlapping being allowed.

5. The display device according to claim 4, wherein
the ID data group is provided with allocation of the display list IDs in accordance with the hierarchical relationships of the display list group.

6. The display device according to claim 1, wherein
the graphics accelerator sets the display list IDs, which are contained in the ID data designated by the ID data arrangement command from the CPU, in the ID table through BitBlt transfer.
